(19) United States
(12) Patent Application Publication
(10) Pub. No.: US 2016/0281434 A1
(43) Pub. Date: Sep. 29, 2016

(54) SEAL ASSEMBLY AND A ROLLER CONE DRILL BIT COMPRISING SUCH A SEAL ASSEMBLY

(71) Applicant: TERCEL IP LTD., Road Town, Tortola (VG)

(72) Inventor: James W. Langford, Jr., Granbury, TX (US)

(73) Assignee: TERCEL IP LTD., Road Town, Tortola (VG)

(21) Appl. No.: 15/037,122

(22) PCT Filed: Nov. 26, 2014
(86) PCT No.: PCT/IB2014/002575

§ 371 Date: May 17, 2016

(30) Foreign Application Priority Data
Nov. 26, 2013 (EP) 13194481.1

(51) Int. Cl. E21B 10/25; F16J 15/16

(52) U.S. Cl. CPC E21B 10/25; F16J 15/16

(57) ABSTRACT

The invention concerns a seal assembly (1) for sealing between a fixed member (10) and a rotatable member (3) adapted for rotating around an axis in relation to said fixed member. The seal assembly comprises a first ring member (4) adapted for being fitted in or on said fixed member circumferentially around said axis and having a first surface (34); a second ring member (6) adapted for being fitted circumferentially in or on said rotatable member and having a second surface (36) facing said first surface along a length; and a third ring member (7) between said second and said first surface, the distance between said second surface and said first surface being larger at the middle of said length and becoming smaller towards the extremities thereof.

### TECHNICAL FIELD

The present invention relates to a seal assembly for sealing between a shaft and rotatable member disposed on the shaft. In a second aspect, the invention relates to a roller cone drill bit comprising such a seal assembly.

### STATE OF THE ART

Roller cone drill bits are drilling tools used in the oilfield and gas industry for drilling wells in earth formations. Roller cone drill bits are attached to a drillstring or a bottom hole assembly. The bit is constructed of at least one leg, generally three legs welded together. A journal or shaft extends on the leg and a roller cone is rotatably mounted on the journal. The roller cone is supported on the journal pin by journal or roller bearings. The roller cone comprises cutting inserts, generally made of tungsten carbide and designed for gouging and crushing the formation being drilled. The bit body comprises nozzles generally directed towards the cutting surfaces of the roller cone or the hole bottom for projecting a drilling fluid providing cleaning and cooling of the surfaces of the roller cone and providing evacuation of the cuttings from the borehole. When drilling a wellbore, the drillstring is rotated, the roller cones roll along the bottom of the hole in a circle and the cutting inserts or teeth in contact with the bottom of the hole crush and gouge the rock that is evacuated by the circular motion of the roller cone and by the drilling fluid.

Generally, sealed roller cone drill bits comprise a grease passage system and a grease system pressure compensation mechanism as disclosed for example in U.S. Pat. No. 6,170,830, for lubricating the bearings. Lubrication of bearings extends the lifetime of the roller cone drill bit. Sealing means are provided at the interface between the journal and the roller cone for retaining lubricant within the journal bearing surface area and for preventing for example drilling fluid, hydrocarbons, and/or drilling debris from impinging upon the interior of the journal/roller cone interface and thereby damaging radial and thrust bearings.

Due to the drilling environment, the sealing means must endure a large range of temperatures and pressures conditions to maintain the lubricant in the space formed between the journal and the roller cone and to prevent contaminants from entering into that space. Despite seals formed as one single ring of rubber or other elastomeric configuration that display excellent sealing properties of elasticity and conformity to mating surfaces, they often have poor tribological properties, high coefficient of friction and low resistance to abrasion, pressure and to high temperatures.

Some attempts to improve the lifetime of O-rings have been done and are discussed in document US2012/0312602. In that document, a reinforcing layer is embedded under the sealing surface of the O-ring, increasing the sealing performance. However, high speed rotation of the roller cone and friction between the surface of the sealing surface of the O-ring and the surface of the journal pin heats the O-ring, which may lead to deformation and reduced lifetime of the O-ring. Also, the roughness and rigidity of the O-ring provided by reinforcement layer and possible wobbling, caused by the drilling forces of the cutting structure, of the roller cone under high speed rotation of the roller cone may still lead to leakage of grease and contamination of the space between the journal and the roller cone by drilled debris. The drilling fluid mixed with debris of cuttings becomes an abrasive fluid that may penetrate within the space between the roller cone and the journal pin and may damage the journal bearings and bushings.

A sealing means for a roller bit is disclosed in document U.S. Pat. No. 5,005,989 and represented in FIG. 1. The roller bit comprising a plurality of legs, each leg having a longitudinally extending pin 111, a cutting cone 112 rotatably mounted on each of said pins by bearing means. A first sealing insert 117 is fixed at the inner end of the pin. The sealing insert 117 made of a material having a hardness greater than the core of the pin 111. A second sealing insert 123 is fixed in the cutting cone 112, the second sealing insert 123 having a hardness of the same magnitude of the first insert 117. An O-ring 118 is arranged between the first sealing insert 117 and the second sealing insert 123, both sealing inserts having the shape of a “L” and having a side 101, 102 in contact with the O-ring arranged parallel to the longitudinal axis of the pin. There is therefore:
a first L shaped ring member 117 only in contact with the pin 111 and having a first outer surface 101 oriented radially outwards;
a first L shaped ring member 223 only in contact with the cone 112 and having a second inner surface 102 oriented radially inwards and facing said first outer surface 101 of the first ring member 117, both first and second surfaces 101, 102 extending along a length in a direction parallel to the axis 110 of the pin 111;
an O-ring 118 member arranged between the first and second ring members 117, 123;
   wherein the radial distance between said first outer surface 101 and said second inner surface 102 is constant.

A first problem of this roller bit is the time consuming fixation of the hard first insert and the second hard insert respectively on the pin and on the cone. Another problem is that the O-ring 118 is an elastomer seal compressed in two points between the first outer surface 101 of the first L shaped ring member 117 and the second inner surface 102 of the second L shaped ring member 123. The O-ring is submitted under high constraints and temperatures which can deform and wear the O-ring. Once the O-ring is deformed or wears out, the sealing effect is affected and the first insert and second insert may enter in contact with each other and provide more friction and more heating.

Another sealing means is disclosed in the document U.S. Pat. No. 4,699,387 and represented in FIG. 2. The sealing means is destined for sealing a cylindrical outer wall 201 against a cylindrical inner wall 202 and comprises:
a first ring member 210 having a first portion 224 and a second portion 226
a second ring member 212 that is a deformable O-ring
a third ring member 211 having a first portion 226 and a second portion 227.

The second ring member 212 is arranged between the first ring member 210 and the third ring member 211. The second ring member 212 urges the first ring member 210 at a first point 220 of the first portion 224 and at a second point 222 of the second portion 222, and urges the third ring member 211 at a first point 221 of the first portion 225 and at a second point 223 of the second portion 227. The second ring member 212 further provides a sealing contact with a first surface 228 of a first cylinder 201 and with a second surface 229 of a second cylinder 202. Prior its use, the second ring member 212 is toroid and while arranged for sealing the cylindrical outer wall 201 against the cylindrical inner wall 202, the two opposite sides 203, 204 forming the sealing contact between the two cylinder's surfaces gets flattened. Such a sealing assembly provides too much friction and would get worn too quickly to be used in a roller cone bit.

Another sealing means for a roller cone bit is disclosed in document US2010/0089657. The roller cone bit comprises a leg 313 provided with a pin 315 having a longitudinal axis 316, the pin 315 on which is mounted a roller cone 317. The cone 317 comprises a groove 331 perpendicular to the axis 316 of the bearing pin 315, the groove 331 in which a sealing means is arranged. The groove comprises a base 334 parallel to the axis 316 of the pin 315. An O-ring 339 engages the groove base 334 and the bearing pin 317. A first companion ring 341 and a second companion ring 383 are arranged in the groove 331 of the cone 317 on both sides of the O-ring 339. The first and second companion rings 341, 383 may engage the groove base 334 and the bearing pin 317. Preferably, the first and second companion rings 341, 383 don't engage the groove base 334 and the pin 315. The O-ring 339 is an elastomer seal and companion rings 383 and 341 are not seals but just seal protectors. The O-ring 339 is compressed in two points 335 and 337 between the groove base 334 and the pin 315. Continuous compression of the O-ring between two parts rotating relative to each other can deform the O-ring, produce friction that accelerates wearing of the O-ring and affect the sealing.

Another sealing means for a roller cone bit is disclosed in document U.S. Pat. No. 4,466,621 and represented in FIG. 4. The sealing means comprises a floating ring 436 arranged between two deformable O-rings 432, 434. A first O-ring 432 can move sealingly against a first bearing surface 430 at the intersection of the leg surface 422 and the pin surface 414. A second O-ring can move sealingly against a second bearing surface 442 which is located in a groove of the roller cone. The floating ring 436 comprises two opposite grooves 440, 440′. The floating ring 436 has a higher Young's modulus than the O-rings 432, 434. The first O-ring 432 is arranged between a first groove 440 and the first bearing surface 430. The second O-ring 434 is arranged between the opposite groove 440′ of the floating ring 436 and the groove 443 made in the cone 410. The floating ring 436 has sharp portions that may enter into contact with the groove 443 of the cone 410 or with the leg surface 422 and the pin surface 414 upon compression of one or both of the O-rings 432, 434 and get worn, bend or damaged, which can affect the sealing effect.

There is still a need to improve the tribological properties of journal bearing seals, to improve their wear resistance, to reduce their coefficient of friction, and improve their temperature endurance and stability.

There is a need to improve roller cone drill bits for preventing contamination of the space between the journal pin and the roller cone and thus preventing damages on the journal bearings and bushings.

### SUMMARY OF THE INVENTION

According to a first aspect, the present invention relates to a seal assembly for sealing between fixed member and a rotatable member adapted for rotating around an axis in relation e.g. by linking or attachment to said fixed member, the seal assembly comprising:
a first ring member adapted for being fitted in or on said fixed member circumferentially around said axis and having a first surface;
a second ring member adapted for being fitted circumferentially in or on said rotatable member 3 and having a second surface facing said first surface along a length; and
a third ring member between said second and said first surface;
the distance between said second surface and said first surface being larger at the middle of said length and becoming smaller towards the extremities thereof.
   The third ring member is preferably in contact with the first and second surface.
   Said fixed member may be a drill bit, comprising a plurality of bit legs.
   Said rotatable member may then be a drill bit cone rotatably mounted around said bit leg.

Preferably, the third ring member is made of a material having a Young modulus higher than the Young modulus of the material of said first ring member in the vicinity of the first surface and/or of the material of the second ring member in the vicinity of the second surface.

Preferably, the third ring member is made of a material having a young modulus higher than 100 GPa.

Preferably, the first surface and said third ring member have a curvature such that said third ring member is contacting said first surface at two points.

Preferably, the second surface and said third ring member have a curvature such that said third ring member is contacting said inner surface at two points.

Alternatively, the first outer surface and said third ring member have a curvature such that said third ring member is contacting said first outer surface at one point.

Alternatively, the second inner surface and said third ring member have a curvature such that said third ring member is contacting said second inner surface at one point.

Preferably, the material of said first ring member in the vicinity of the first surface and/or the material of the second ring member in the vicinity of the second surface comprise an elastomer.

Preferably, the third ring member is coated with a friction-reducing material.

Preferably, the first ring member is adapted for fitting on or in said fixed member in a non-rotatable way.

Preferably, the second ring member is adapted for fitting on or in said rotatable member in a non-rotatable way.

In a first embodiment of the invention, the fixed member comprises a shaft and said rotatable member comprises a cavity, said shaft and said cavity being adapted for rotation of said rotatable member around said axis.

In a first variation of the first embodiment, the first ring member is adapted for being fitted around said shaft, said first surface being oriented radially outwards; said second ring member is adapted for being fitted inside said cavity of said rotatable member, said second inner surface being oriented radially inwards and facing said first surface, said length extending in a direction parallel to said shaft.

In a second variation of the first embodiment, the first ring member is adapted for being fitted on a surface of fixed member perpendicular to said shaft, said first surface being oriented axially in the direction of said shaft; said second ring member is adapted for being fitted on said rotatable member, said second surface being oriented axially in the direction of said shaft and facing said first surface, said length extending in a direction radial to said shaft.

In a third variation of the first embodiment, the first ring member is adapted for being fitted on a surface of said fixed member oriented in a direction intermediate between a radially outwards direction and an axial direction in the direction of said shaft; said second ring member is adapted for being fitted inside said rotatable member, said second inner surface being oriented in a direction facing said first outer surface, said length extending in a direction perpendicular to said intermediate direction.

In a second embodiment of the invention, the fixed member comprises a cavity and said rotatable member comprises a shaft, said shaft and said cavity being adapted for rotation of said rotatable member around said axis.

In a first variation of the second embodiment, the first ring member is adapted for being fitted inside said cavity of said fixed member, said first surface being oriented radially inwards; said second ring member is adapted for being fitted around said shaft of said rotatable member, said second surface being oriented radially outwards and facing said first surface, said length extending in a direction parallel to said shaft.

In a second variation of the second embodiment, the first ring member is adapted for being fitted on a surface of fixed member perpendicular to said cavity, said first surface being oriented axially in the direction of said shaft; said second ring member is adapted for being fitted on said rotatable member, said second surface being oriented axially in the direction of said shaft and facing said first surface, said length extending in a direction radial to said shaft.

In a third variation of the second embodiment, the first ring member is adapted for being fitted on a surface of said fixed member oriented in a direction intermediate between a radially inwards direction and an axial direction in the direction of said shaft; said second ring member is adapted for being fitted around said rotatable member said second inner surface being oriented in a direction facing said first outer surface, said length extending in a direction perpendicular to said intermediate direction.

According to a second aspect, the present invention relates to a roller cone drill bit comprising
a bit leg;
at least one shaft extending from a portion of said bit leg;
a roller cone rotatably mounted on said shaft; and
a seal assembly as disclosed herein above, wherein said first ring member is fixed to said shaft and said second ring member is fixed to said roller cone.

Preferably, the roller cone comprises a groove for insertion of said second ring member.

Preferably, the bit leg comprises a first substantially flat surface, said roller cone comprises a second groove aligned with each other, centered on the central axis of the shaft, and in which is substantially flat surface facing said first substantially flat surface, both surfaces having a circularly disposed a fourth ring member.

Preferably, the fourth ring member comprises a cavity at its periphery.

Preferably, the cavity of said fourth ring member extends along the entire perimeter of the said fourth ring member.

Preferably, the fourth ring member is made of a material having a Young's modulus superior to 100 GPa.

Preferably, the fourth ring member is coated with a friction-reducing material.

### Alternatively, the Present Invention can be Disclosed as:

a seal assembly (1) for sealing a first member (10) and a second member (3), arranged coaxially to rotate relative to each other, the seal assembly (1) comprising:
a first ring member (4) adapted to be fastened to the first member (10) and comprising a first concave and deformable surface (34);
a second ring member (6) adapted to be fastened to the second member (3) and comprising a second concave and deformable surface (36) adapted to face the first concave surface (34);
a third ring member (7) more rigid and less deformable than both the said first surface (34) and the said second surface (36), the third ring member (7) being adapted to be arranged between the said first concave surface (34) and the said second concave surface (36).

Preferably, the seal assembly (1) is characterized in that said first concave surface (34) and said second concave surface (36) provide multiple sealing surfaces (9a, 9b, 9c, 9d) contacting said third ring member (7) thus allowing the said third ring member (7) to rotate freely between the said first concave surface (34) and the second concave surface (36) and in self-alignment relative to the movement of the rotatable member (3).

Preferably, the seal assembly (1) is characterized in that said third ring member (7) is made of a material having a Young modulus higher than the Young modulus of the material of said first ring member (4) in the vicinity of the first surface (34) and of the material of the second ring member (6) in the vicinity of the second surface (36).

Preferably, the seal assembly (1) is characterized in that the said third ring member (7) is made of a material having a young modulus higher than 100 GPa.

Preferably, the seal assembly (1) is characterized in that the said first concave surface (34) comprises a first deeper area (40) out of contact with the said third ring member (7) and two areas (9a, 9b) on both sides of the said first deeper area (40) providing a sealing surface in contact with the third ring member (7), and the said second concave surface (36) comprises a second deeper area (41) out of contact with the said third ring member (7) and two areas (9c, 9d) on both sides of the second deeper area (41) providing a sealing surface in contact with the said third ring member (7).

Preferably, the seal assembly (1) is characterized in that the material of said first ring member (4) in the vicinity of the first surface (34) and/or the material of the second ring member in the vicinity of the second surface (36) comprise an elastomer.

Preferably, the seal assembly (1) is characterized in that said third ring member (7) is coated with a friction-reducing material.

In a second aspect, the present invention relates to a roller cone drill bit (100) comprising
a bit leg (10);
at least one shaft (2) extending from a portion of said bit leg (10);
a roller cone (3) rotatably mounted on said shaft (2);
   characterized in that it comprises a seal assembly (1) as presented above, wherein said first ring member (4) is fixed to said shaft (2) and said second ring member (6) is fixed to said roller cone (3).

Preferably, the roller cone drill bit (100) is characterized in that the roller cone (3) comprises a groove (11) for insertion of said second ring member (6).

Preferably, the roller cone drill bit (100) is characterized in that the bit leg (10) comprises a first substantially flat surface (12), said roller cone (3) comprises a second substantially flat surface (13) facing said first substantially flat surface (12), both surfaces (12, 13) having a circular groove (14, 14′) aligned with each other, centered on the central axis (15) of the shaft (2), and in which is disposed a fourth ring member (16).

Preferably, the roller cone drill bit (100) is characterized in that said fourth ring member (16) comprises a cavity (17) at its periphery.

Preferably, the roller cone drill bit (100) is characterized in that said cavity (17) of said fourth ring member (16) extends along the entire perimeter of the said fourth ring member (16).

Preferably, the roller cone drill bit (10) is characterized in that said fourth ring member (16) is made of a material having a Young's modulus superior to 100 GPa.

Preferably, the roller cone drill bit (10) is characterized in that said fourth ring member (16) is coated with a friction-reducing material.

### DESCRIPTION OF DRAWINGS

FIG. 1 shows a first sealing means of prior art.

FIG. 2 shows a second sealing means of prior art.

FIG. 3 shows a third sealing means of prior art.

FIG. 4 shows a second sealing means of prior art.

FIG. 5a shows sectional view of a portion of a roller cone drill bit comprising a seal assembly according to a first variation of a first embodiment of the present invention.

FIG. 5b shows a sectional expanded view of an arrangement of the seal assembly into the roller cone drill bit of FIG. 5a.

FIGS. 5c, 5d and 5e show three examples of combinations of curvatures and shapes of the ring members of the seal assembly according to different embodiments of the invention.

FIG. 5f shows a sectional expanded view of an arrangement of the seal assembly into the roller cone drill bit according to a second variation of the first embodiment of the present invention.

FIG. 5g shows a sectional expanded view of an arrangement of the seal assembly into the roller cone drill bit according to a third variation of the first embodiment of the present invention.

FIG. 6a shows a portion of a roller cone drill bit according to a second embodiment of the present invention.

FIG. 6b shows an expanded view of an arrangement of the seal assembly into the roller cone drill bit according to said second embodiment of the present invention.

FIG. 7a shows a cross section of a first ring member of the seal assembly according to an embodiment of the present invention.

FIG. 7b shows a cross section of a first ring member of the seal assembly according to another embodiment of the present invention.

FIG. 7c shows a cross section of a first ring member of the seal assembly according to another embodiment of the present invention.

FIG. 8a shows a cross section of a second ring member of the seal assembly according to an embodiment of the present invention.

FIG. 8b shows a cross section of a second ring member of the seal assembly according to another embodiment of the present invention.

FIG. 9 shows a perspective three dimensional view of a roller cone drill bit according to the present invention.

### DETAILED DESCRIPTION OF PREFERRED EMBODIMENTS THE INVENTION

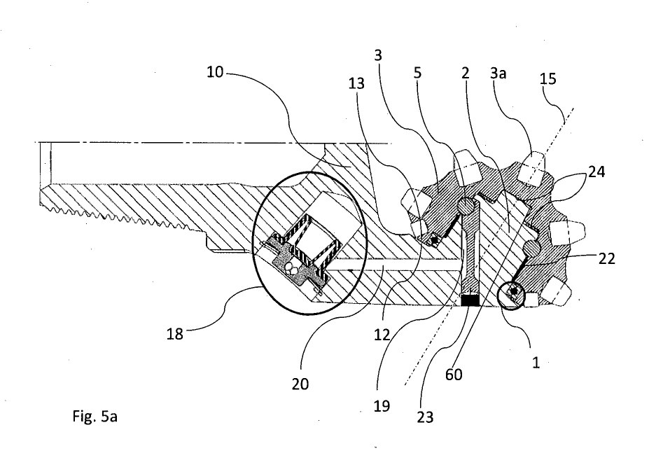

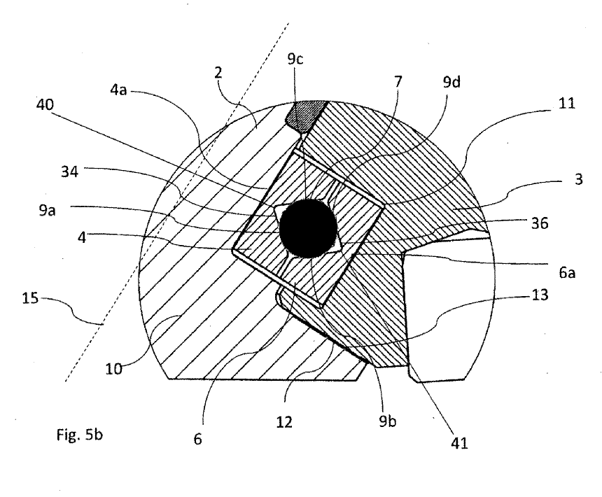

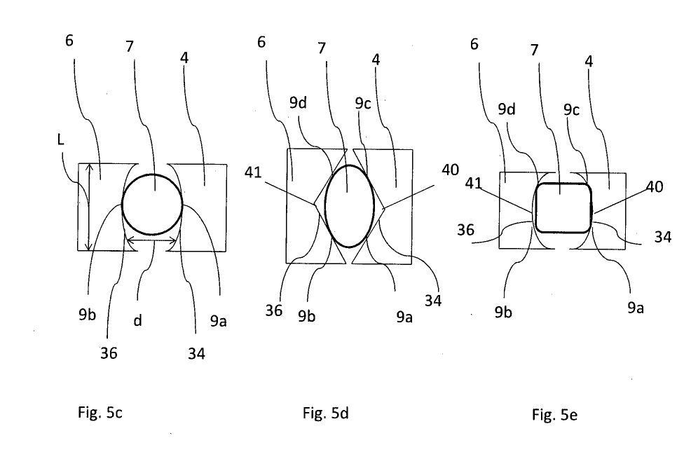

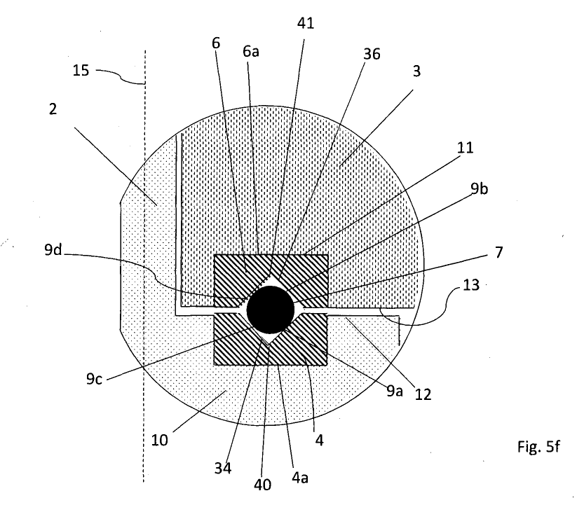

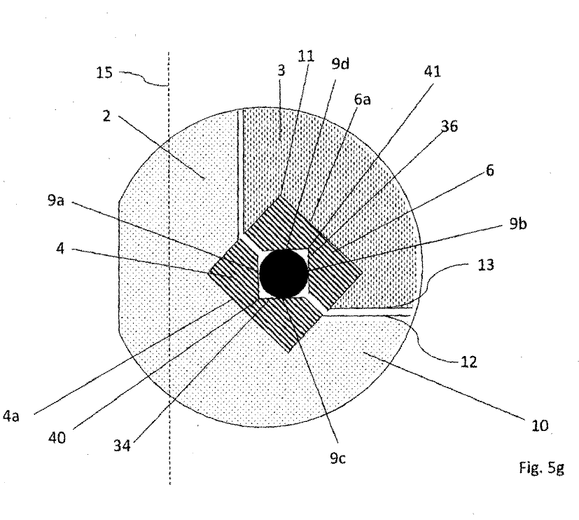

Referring to FIG. 5a to 5e, the present invention relates to a seal assembly 1 for a roller cone drill bit 100 for sealing between a shaft 2 and rotatable member 3 disposed on the shaft 2.

The seal assembly 1 comprises:
a first ring member 4 to be fixed to the shaft 2 and comprising a first outer surface 34;
a second ring member 6 to fixed to the rotatable member 3 and comprising a second inner surface 36;
a third ring member 7 between the first ring member 4 and the second ring member 6.

The first ring member 4 comprises a first outer surface 34 along the outer periphery of the first ring member 4. The second ring member comprises a second inner surface 36 along the inner periphery of the second ring member 6. The two surfaces 34 and 36 are facing each other along a length.

The vicinity of the first outer surface 34 of the first ring member 4 and the vicinity of the second inner surface 36 of the second ring member are made of substantially deformable materials, whereas the third ring member 7 is made of a stiffer material than both vicinity of first outer surface 34 and second inner surface 36. It is also important that each of the first outer surface 34 and the second inner surface 36 are in contact with said third ring member 7 so as to provide an efficient sealing between the rotatable member 3 and the shaft 2. Preferably, both first outer surface 34 and second inner surface 36 are not in contact with each other for minimizing friction forces between the rotatable member 3 and the shaft 2 while the rotatable member 3 rotates relative to the shaft 2.

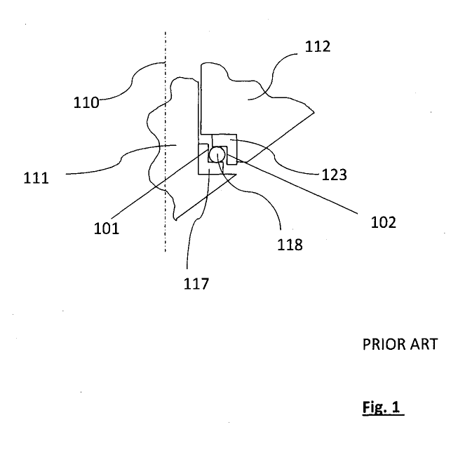

FIGS. 5c, 5d and 5e show three examples of combinations of curvatures and shapes of the ring members of the seal assembly according to different embodiments of the invention. In all three embodiments, the surfaces 36 and 34 face each other along a length L, and along the whole periphery of the seal assembly. The distances d between the two facing surfaces 34 and 36 is larger at the middle and is progressively reduced up to the extremities of the length. Thereby a volume is enclosed, and the third ring member is maintained at a proper position at or near the middle of the length. The third ring member is self aligning: should the third ring member deviate from its optimal position, e.g. upwards in the figures, it would be coerced to go back to its design position by the reduced distance available. In the example of FIG. 1c, the curvature of the first outer surface 34 and the shape of the third ring member 7 are such that a single contact point 9a in the axial section exists between third radial member 7 and first outer surface 34. The contact 9a might also extend along some length and form, along the periphery of the outer surface 34, a contact surface 9a. Similarly, the curvature of the second outer surface 36 and the shape of the third ring member 7 are such that a single contact point 9b in the axial section exists between third radial member 7 and second inner surface 36. Similarly, the contact 9b may extend and form a contact surface. In the advantageous embodiments of FIGS. 5d and 5e, the curvatures and shape are such that two contact points 9a, 9c exist between the third ring member 7 and the first outer surface 34, and two contact points 9b, 9d exists between the third ring member 7 and the second inner surface 36. Combinations with one contact point on one side and two on the other one may also be made. These contact points may also extend and form contact surfaces. Preferably, no additional contact point exists besides contact points 9a and 9c, or 9b and 9d. The advantage of having two surfaces separated from each other on both side of the third ring member 7 is that the contact forces between the third ring member 7 and both surfaces are distributed on two points on each surface 34, 36 of the first and second ring member 4, 6, reducing therefore the load and the resulting fatigue on the deformable surfaces 34, 36 of the first and second ring members 4, 6. The lifetime of the seal assembly is therefore prolonged. The other advantage of having two contact surfaces separated from each other on both side of the third ring member 7 is that the friction between the first ring member 4 and the third ring member 7 and the friction between the second ring member 6 and the third ring member 7 are kept at a low level relative to an embodiment wherein the whole outer surface 34 of the first ring member 4 and the whole inner surface 36 of the second ring member would be in contact with the third ring member 7. In the example of FIG. 1b and FIG. 1d, the two contact points are obtained by using surfaces 34, 36 having a V-shape, and a substantially circular third ring member. In the example of FIG. 5e, the two contact points are obtained with more regular curves 34, 36, but with a third ring member 7 having a substantially rectangular shape, having rounded edges, two first rounded edges being in contact with the first outer surface 34 of the first ring member 4 and two second rounded edges being in contact with the second outer surface of the third ring member 7.

The material of the first ring member, at least in the vicinity of the first outer surface 34, and of the second ring member, at least in the vicinity of the second inner surface 36, may comprise rubber or an elastomeric material selected from the group including but non-limited to acrylonitrile polymers including acrylonitrile-butadiene rubber (NBR) hydrogenated nitrile butadiene rubber (HNBR), carboxylated acrylonitrile butadiene, carboxylated hydrogenated acrylonitrile butadiene, ethylene propylene, ethylene propylene diene, fluoroelastomers, tetrafluoroethylene-propylene copolymers, fluorocarbons, perfluoroelastomers and the like, and mixtures thereof.

Advantageously, at least one of the said first ring member 4 and the second ring member 6 are made of one of the said elastomeric or rubber materials cited above and comprise one or more lubricant additives to provide enhanced properties of wear and friction reduction such as but non-limited to polytetrafluoroethylene, molybdenum disulfide, graphite flake, hexagonal boron nitride and the like, and mixture thereof.

In an embodiment of the present invention, at least one of the whole first ring member 4 and the whole second ring member 6 are made of rubber or elastomeric material as disclosed herein above, preferably including one or more lubricant additives as disclosed herein above.

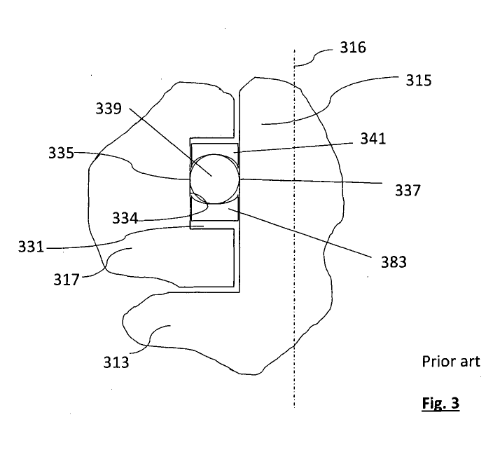

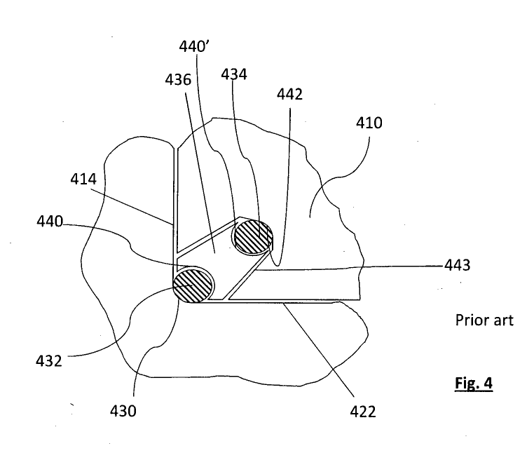

In another embodiment of the present invention, at least one of the first ring member 4 and second ring member 6 comprise a reinforcing material 4b, 6b, located below 5 the first outer surface 34 or second inner surface 36, for example embedded in the ring member as presented on FIGS. 3c and 4b. The reinforcing material is selected from the group including but non-limited to elastomeric materials or non elastomeric materials including plastic, fabric, composite materials harder (i.e. having a higher Young's modulus) than the material of the ring members 4,6 in the vicinity of the surfaces 34, 36. Non limitative example of reinforcing materials include fibers such as glass fibers, polyester fibers, cotton fibers, stainless steel fibers, aromatic polyamines (Kevlar) fibers, polybenzimidazole fibers, poly m-phenyleneisophtalamide fibers and mixtures or blends thereof.

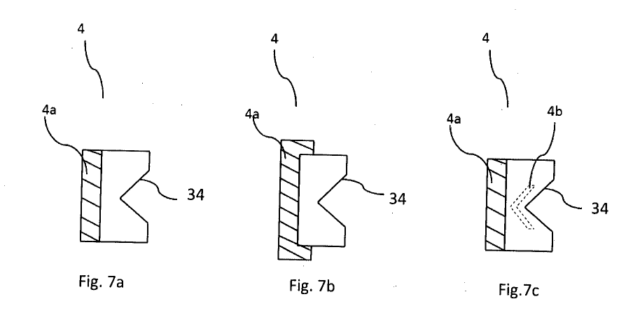

FIGS. 7a to 7c shows others embodiments of said first ring member 4 which comprises a contacting surface 4a in contact with the shaft 2. It is preferred that the assembly is such that no rotation or slip occurs between the first ring member 4 and the shaft 2. This occurs for example by pressing the ring member 4 onto the shaft 2 by interference fit or by other securing means. The contacting surface 4a of the first ring member 4 can be made of a material more rigid than the material of said first outer surface 34. In an embodiment of the present invention, the contacting surface 4a is made of a metal. In the embodiment presented on FIG. 3b, the contacting surface 4a has a C shape for securing the deformable portion of the ring and preventing rotation of the ring member 4 against the shaft while maintaining a sealing force against the third ring member 7.

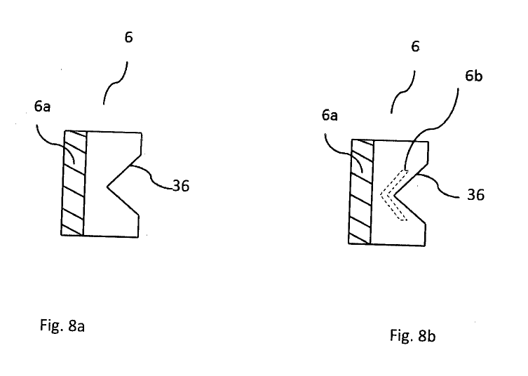

The said second ring member 6 comprises a contacting surface 6a in contact with the said rotatable member 3. It is preferred that the assembly is such that no rotation or slip occurs between the second ring member 6 and the rotatable member 3. This occurs when the friction force between the contacting surface 6a and the rotatable member is higher than the friction force between the second cavity surface 36 and the third ring member 7. In an embodiment of the invention as presented on FIGS. 8a and 8b, the contacting surface 6a of the said second ring member is made of a material more rigid than the said second inner surface 36. The non-rotatable fit may also be obtained by selecting the sizes of the second ring member 6 and the rotatable member 3 such that a tight fit exist. Also a pin in one element and corresponding notch in the other one may prevent rotation.

Preferably, said third ring member 7 is made of a material having a Young's module larger than 100 GPa. Preferred materials for said third ring member are selected from alloys or ceramics. More preferred materials must have good properties of stiffness, good chemical inertia, resistance to wear and to high temperatures. Advantageously, the third ring member should have a low cost of production. Those preferred materials include brass, bronze copper, beryllium bronze, 18-10 stainless steel, steel, and zirconium dioxide. These materials are not limitative to the present invention.

Preferably, the third ring member 7 is coated with a material minimizing friction between said third ring member 7 and both of said first ring member 4 and said second ring member 6.

Advantageously, the coating material must provide a low friction coefficient on the first contacting surface 34 and the second contacting surface 36. Such a coating material must also have a good adhesion on the substrate, a good resistance to wear and to high temperatures. Preferred coating materials for the third ring member 7 includes PTFE (Polytetrafluoroethylene), PTFE/Molybdenum disulfide, PTFE/graphite, graphite and Molybdenum disulfide, Titanium carbide, chromide carbide and diamond like carbon. These materials are not limitative to the present invention.

Preferably, the third ring member 7 is toroidal. The first ring member 4 provides 2 surfaces of sealing 9a, 9c contacting the third ring member 7, and the second ring member 6 provide 2 surfaces of sealing 9b, 9d contacting the third ring member 7.

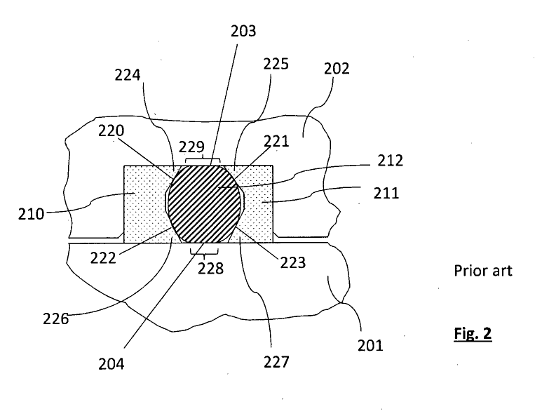

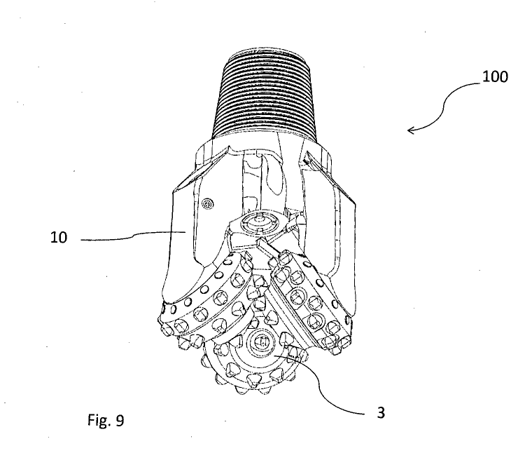

According to a second aspect, the present invention relates to a roller cone drill bit 100. An example of a perspective three dimensional view of a roller cone drill bit is represented in the FIG. 9. A portion of such a roller cone drill bit 100 is represented on FIGS. 1a and 2a. The roller cone drill bit 100 comprises:
A bit leg 10;
At least one shaft or journal pin 2 extending from a portion of the bit leg 10;
A roller cone 3 rotatably mounted on the shaft 2.
   The roller cone drill bit is characterized in that it comprises a seal assembly 1 comprising at least:
a first ring member 4 adapted for fitting around said shaft 2 and having a first outer surface 34 oriented radially outwards;
a second ring member 6 adapted for fitting inside said roller cone 3 and having a second inner surface 36 oriented radially inwards and facing said first outer surface 34 along an length extending in a direction parallel to said shaft; and
a third ring member 7 between said second inner 36 and said first outer surface 34, the seal assembly, wherein the radial distance between said second inner surface 36 and said first outer surface 34 being larger at the middle of said length and becoming smaller towards the extremities thereof, and wherein said first ring member 4 is fixed to said shaft 2 and said second ring member 6 is fixed to said roller cone 3. The seal assembly 1 of the roller cone drill bit 100 may comprises any other features as disclosed in the description of the seal assembly 1 herein above.

The roller cone 3 comprises hard material cutting inserts 3a, preferably made of tungsten carbide. Preferably, the roller cone 3 comprises a base 13 facing a substantially flat surface 12 of the bit leg 10. The base 13 of the roller cone 3 comprises a cavity designed for inserting a shaft or journal pin 2 rising from the substantially flat surface 12 of the bit leg 10 and for the bearing members and cone retention ball bearings 5. Both journal pin 2 and cavity of the roller cone 3 comprises complementary bearing races for cone retention ball bearings 5, radial bearings 22 and thrust bearing 24. The journal pin 2 further comprises a first channel 19 for introducing balls 5. The first channel 19 is closed by a ball retainer 23 fixed, typically by welding, inside the channel once the balls 5 are in place. More preferably, the journal pin 2 further comprises a second channel 20 connected to the first channel 19 and to a reservoir 18 containing a lubricant for lubrication of the bearing system 5, 22 and 24. The channel for the lubricant to enter the bearing is through the ball race. It is from that point that the lubricant is distributed throughout the bearing system. When lubricated, the space between the journal pin 2 and the cavity of the roller cone 3 is completely filled with lubricant. A third channel 21 may be provided in connection with one of the first or second channel and one of the radial bearings 22 or thrust bearings 24 for allowing the circulation of the lubricant.

The seal assembly is arranged in the roller cone drill bit such that said first ring member 4 and said second ring member 6 provide multiple sealing surfaces 9a, 9b, 9c, 9d contacting said third ring member 7 thus allowing the said third ring member 7 to rotate freely between the said first outer surface 34 and the second inner surface 36 and in self-alignment relative to the movement of the rotatable member 3.

Preferably, the journal pin 2 comprises a bottom section adjacent to the bit leg, the bottom section having a bigger diameter for making a press fit between that bottom section and the first ring member 4.

The said cavity of the roller cone comprises a recess or preferably a groove 11 having for example a rectangular cross section machined parallel to the base 13 of the roller cone for inserting said seal assembly.

The method of mounting the roller cone drill bit includes the steps of:
pressing the first ring 4 on the bottom section of the journal 2;
inserting the third ring member 7 into the cavity of the first ring 4;
putting the radial bearings 22 and the thrust bearings 24 onto the races provided on the journal and putting the second ring 6 into the recess or groove 11 of the roller cone 3;
pressing the roller cone onto the loaded journal until the third ring member 7 is in place into the cavity of the second ring member 6;
inserting the balls 5 into the channel 19 provided through the journal 2 for loading the bearing races and maintaining the roller cone 3 on the journal 2;
welding the ball retainer 23 into the said channel 19.

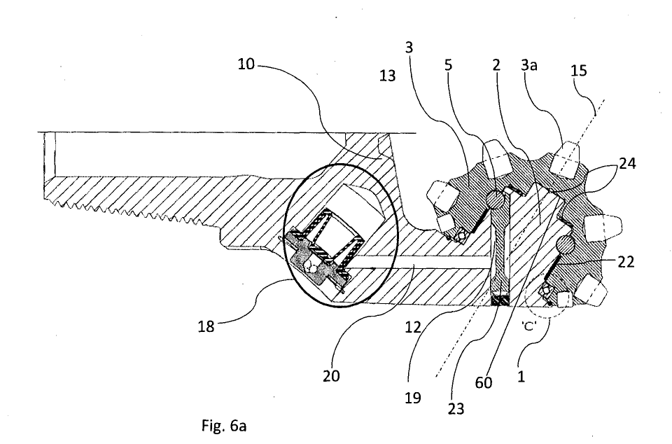

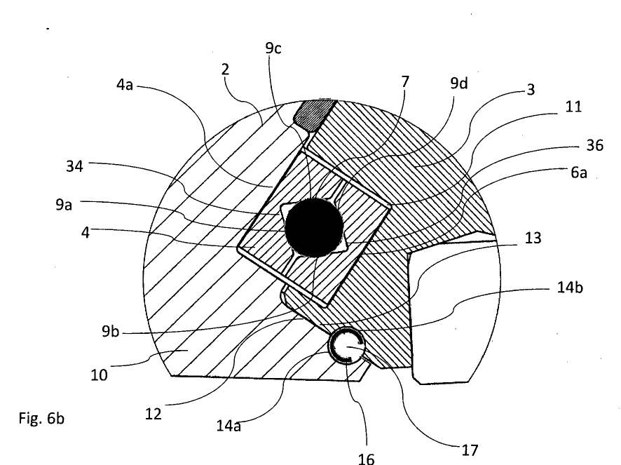

In another embodiment of the invention, as presented on FIGS. 6a and 6b the substantially flat surface 12 of the bit leg 10 facing the base 13 of the roller cone, and the base of the roller cone both comprises a semi-circular cross section groove 14a, 14b aligned with each other, centered on the central axis 15 of the journal pin 2, and in which is disposed a fourth ring member 16. The fourth ring member provides a first barrier preventing the debris of cutting to penetrate between the journal pin and the roller cone. There is a clearance between the fourth ring member 16 and the space formed by the two facing semi-circular grooves 14a, 14b for equilibrating pressures.

Preferably, the fourth ring member 16 comprises a cavity 17 at its periphery. More preferably, the cavity 17 of the fourth ring member 16 extends along the entire perimeter of the said fourth ring member 16. Larger particles of debris are trapped by this cavity and fluid flowing through this cavity tends to remove these particles out of the cavity and out of the space between the base of the roller cone and the flat surface of the body facing the base of the roller cone.

More preferably, fourth ring member 16 is made of a material having a Young's modulus larger than 100 GPa such as the possible materials disclosed hereinabove for the said third ring member.

Preferably, said fourth ring member 16 is coated with an abrasive resistant coating such as Titanium nitride, or aromatic polyamine (Kevlar). Said fourth ring member can also be carburized or boronized.

Preferably, the roller cone bearing surfaces are hardened, and journal surfaces are hardened typically by carburizing or boronizing the steel surfaces.

The seal assembly as disclosed herein above and its use for sealing a space formed by a journal and a cavity of a roller cone provides the advantages of an improved sealing and an increased lifetime of the sealing relative to prior art sealing means, in particular in the field of roller cone drill bits.

While drilling with a roller cone drill bit comprising the seal assembly as disclosed hereinabove, the relative speed of the sealing ring 7 that floats freely in the cavities formed by 34 and 36 will be typically less than the rotational speed of the cone, thus limiting the heat generation of the seal due to frictional forces. This improvement of this seal was not possible with other typical sealing system configurations.

Alternatively, the present invention can be described as herein below.

Referring to FIG. 5a to 5g, the present invention relates to a seal assembly 1 for sealing a first member 10 and a second member 3 wherein the first member 10 and the second member 3 comprise parts arranged coaxially to rotate relative to each other, the sealing assembly comprising:
a first ring member 4 adapted to be fastened to the first member 10 and comprising a first concave and deformable surface 34;
a second ring member 6 adapted to be fastened to the second member 3 and comprising a second concave and deformable surface 36 adapted to face the first concave surface 34; and
a third ring member 7 more rigid and less deformable than both the said first concave surface 34 and the said second concave surface 36, the third ring member 7 being adapted to be arranged between the said first concave surface 34 and the said second concave surface 36.

In the context of the present invention, we define the orientation of a surface of a member as a vector normal to said surface and pointing to the outside of said member. When the surface have a curvature, we will consider the orientation of the surface as being the mean of the vectors normal to the surface.

FIGS. 5a and 5b represent the preferred variation of the first embodiment of a seal assembly 1 for a roller cone drill bit 100 for sealing between a shaft 2 and rotatable member 3 disposed on the shaft 2. The seal assembly 1 comprises:
a first ring member 4 to be fixed to the shaft 2 and comprising a first outer surface 34 also referred as first concave surface 34;
a second ring member 6 to be fixed to the rotatable member 3 and comprising a second inner surface 36 also referred as second concave surface 36;
a third ring member 7 between the first ring member 4 and the second ring member 6.

In that embodiment, the first concave surface 34 of the first ring member 4 and the second concave surface 36 of the second ring member 6 are both oriented perpendicularly to the axis 15 of the shaft 2, the first surface 34 radially outwards, and the second surface radially inwards. The first ring member 4 comprises a first outer surface 34 along the outer periphery of the first ring member 4. The second ring member comprises a second inner surface 36 along the inner periphery of the second ring member 6. The two surfaces 34 and 36 are facing each other along a length.

In a second variation of said first embodiment, presented in the FIG. 5f, the first concave surface 34 of the first ring member 4 and the second concave surface 36 of the second ring member 6 are both oriented perpendicularly to the plane of both ring members 4, 6 and parallel to the axis 15 of the shaft.

In third variation of the first embodiment, presented in the FIG. 5g, the first concave surface 34 of the first ring member 4 and the second concave surface 36 of the second ring member 6 are both oriented such as to form an angle intermediate between 0° and 90° with the plane of both ring members 4,6 and to form a complementary angle with the axis 15 of the shaft 2.

In a second embodiment of the invention, not represented, the fixed member comprises a cavity and the rotatable member comprises a shaft rotatably mounted in said cavity. Corresponding first, second and third variation of the arrangement of the seal assembly with respect to radial, axial or intermediate orientation of the first and second surfaces exist.

The vicinity of the first concave surface 34 of the first ring member 4 and the vicinity of the second concave surface 36 of the second ring member are made of substantially deformable materials, whereas the third ring member 7 is made of a stiffer material than both vicinity of first concave surface 34 and second concave surface 36. It is also important that each of the first concave surface 34 and the second concave surface 36 are in contact with said third ring member 7 so as to provide an efficient sealing between the rotatable member 3 and the shaft 2. Preferably, both first concave surface 34 and second concave surface 36 are not in contact with each other for minimizing friction forces between the rotatable member 3 and the shaft 2 while the rotatable member 3 rotates relative to the shaft 2.

FIGS. 5c, 5d and 5e show three examples of combinations of curvatures and shapes of the ring members of the seal assembly according to different embodiments of the invention, regardless the orientations of the concave surfaces relative to the plane of their respective ring members. In all three embodiments, the surfaces 36 and 34 face each other along a length L, and along the whole periphery of the seal assembly. The distances d between the two facing surfaces 34 and 36 is larger at the middle and is progressively reduced up to the extremities of the length. Thereby a volume is enclosed, and the third ring member is maintained at a proper position at or near the middle of the length. The third ring member is self aligning: should the third ring member deviate from its optimal position, e.g. upwards in the figures, it would be coerced to go back to its design position by the reduced distance available.

In the example of FIG. 5c, the curvature of the first concave surface 34 and the shape of the third ring member 7 are such that a single contact point 9a in the axial section exists between third radial member 7 and first concave surface 34. The contact 9a might also extend along some length and form, along the periphery of the concave surface 34, a contact surface 9a. Similarly, the curvature of the second concave surface 36 and the shape of the third ring member 7 are such that a single contact point 9b in the axial section exists between the third radial member 7 and the second concave surface 36. Similarly, the contact 9b may extend and form a contact surface.

In the advantageous embodiments of FIGS. 5d and 5e, the curvatures and shape are such that two contact points or areas 9a, 9c exist between the third ring member 7 and the first concave surface 34, and two contact points or areas 9b, 9d exists between the third ring member 7 and the second concave surface 36. The first concave surface 34 comprises a first deeper area 40 out of contact with the said third ring member 7 and two areas 9a, 9b on both sides of the said first deeper area 40 providing a sealing surface in contact with the third ring member 7. The said second concave surface 36 comprises a second deeper area 41 out of contact with the said third ring member 7 and two areas 9c, 9d on both sides of the second deeper area 41 providing a sealing surface in contact with the said third ring member 7.

Combinations with one contact point on one side and two on the other one may also be made. These contact points may also extend and form contact surfaces. The advantage of having two areas providing two contact surfaces on both sides of a deeper area out of contact with the third ring member and separated from each other on both side of the third ring member 7 is that the contact forces between the third ring member 7 and both concave surfaces are distributed on two points on each concave surface 34, 36 of the first and second ring member 4, 6, reducing therefore the load and the resulting fatigue on the deformable surfaces 34, 36 of the first and second ring members 4, 6. The lifetime of the seal assembly is therefore prolonged. The other advantage of having two areas providing two contact surfaces separated from each other by a deeper area out of contact with the third ring member, on both side of the third ring member 7 is that the friction between the first ring member 4 and the third ring member 7 and the friction between the second ring member 6 and the third ring member 7 are kept at a low level relative to a embodiment wherein the whole concave surface 34 of the first ring member 4 and the whole second concave surface 36 of the second ring member would be in contact with the third ring member 7. In the example of FIG. 5b and FIG. 5d, the two contact points are obtained by using concave surfaces 34, 36 having a V-shape, and a substantially circular third ring member. In the example of FIG. 5e, the two contact points are obtained with more regular curves 34, 36, but with a third ring member 7 having a substantially rectangular shape, having rounded edges, two first rounded edges being in contact with the first concave surface 34 of the first ring member 4 and two second rounded edges being in contact with the second concave surface of the third ring member 7.

The material of the first ring member, at least in the vicinity of the first concave surface 34, and of the second ring member, at least in the vicinity of the second concave surface 36, may comprise rubber or an elastomeric material selected from the group including but non-limited to acrylonitrile polymers including acrylonitrile-butadiene rubber (NBR) hydrogenated nitrile butadiene rubber (HNBR), carboxylated acrylonitrile butadiene, carboxylated hydrogenated acrylonitrile butadiene, ethylene propylene, ethylene propylene diene, fluoroelastomers, tetrafluoroethylene-propylene copolymers, fluorocarbons, perfluoroelastomers and the like, and mixtures thereof.

Advantageously, at least one of the said first ring member 4 and the second ring member 6 are made of one of the said elastomeric or rubber materials cited above and comprise one or more lubricant additives to provide enhanced properties of wear and friction reduction such as but non-limited to polytetrafluoroethylene, molybdenum disulfide, graphite flake, hexagonal boron nitride and the like, and mixture thereof.

In an embodiment of the present invention, at least one of the whole first ring member 4 and the whole second ring member 6 are made of rubber or elastomeric material as disclosed herein above, preferably including one or more lubricant additives as disclosed herein above.

In another embodiment of the present invention, at least one of the first ring member 4 and second ring member 6 comprise a reinforcing material 4b, 6b, located below the first concave surface 34 or second concave surface 36, for example embedded in the ring member as presented on FIGS. 7c and 8b. The reinforcing material is selected from the group including but non-limited to elastomeric materials or non elastomeric materials including plastic, fabric, composite materials harder (i.e. having a higher Young's modulus) than the material of the ring members 4,6 in the vicinity of the concave surfaces 34, 36. Non limitative example of reinforcing materials include fibers such as glass fibers, polyester fibers, cotton fibers, stainless steel fibers, aromatic polyamines (Kevlar) fibers, polybenzimidazole fibers, poly m-phenyleneisophtalamide fibers and mixtures or blends thereof.

FIGS. 7a to 7c shows others embodiments of said first ring member 4 which comprises a contacting surface 4a in contact with the shaft 2. It is preferred that the assembly is such that no rotation or slip occurs between the first ring member 4 and the shaft 2. This occurs for example by pressing the ring member 4 onto the shaft 2 by interference fit or by other securing means. The contacting surface 4a of the first ring member 4 can be made of a material more rigid than the material of said first concave surface 34. In an embodiment of the present invention, the contacting surface 4a is made of a metal. In the embodiment presented on FIG. 7b, the contacting surface 4a has a C shape for securing the deformable portion of the ring and preventing rotation of the ring member 4 against the shaft while maintaining a sealing force against the third ring member 7.

The said second ring member 6 comprises a contacting surface 6a in contact with the said rotatable member 3. It is preferred that the assembly is such that no rotation or slip occurs between the second ring member 6 and the rotatable member 3. This occurs when the friction force between the contacting surface 6a and the rotatable member is higher than the friction force between the second cavity surface 36 and the third ring member 7. In an embodiment of the invention as presented on FIGS. 8a and 8b, the contacting surface 6a of the said second ring member is made of a material more rigid than the said second concave surface 36. The non-rotatable fit may also be obtained by selecting the sizes of the second ring member 6 and the rotatable member 3 such that a tight fit exist. Also a pin in one element and corresponding notch in the other one may prevent rotation.

Preferably, said third ring member 7 is made of a material having a Young's module larger than 100 GPa. Preferred materials for said third ring member are selected from alloys or ceramics. More preferred materials must have good properties of stiffness, good chemical inertia, resistance to wear and to high temperatures. Advantageously, the third ring member should have a low cost of production. Those preferred materials include brass, bronze copper, beryllium bronze, 18-10 stainless steel, steel, and zirconium dioxide. These materials are not limitative to the present invention.

Preferably, the third ring member 7 is coated with a material minimizing friction between said third ring member 7 and both of said first ring member 4 and said second ring member 6. Advantageously, the coating material must provide a low friction coefficient on the first contacting surface 34 and the second contacting surface 36. Such a coating material must also have a good adhesion on the substrate, a good resistance to wear and to high temperatures. Preferred coating materials for the third ring member 7 includes PTFE (Polytetrafluoroethylene), PTFE/Molybdenum disulfide, PTFE/graphite, graphite and Molybdenum disulfide, Titanium carbide, chromide carbide and diamond like carbon. These materials are not limitative to the present invention.

Preferably, the third ring member 7 is toroidal. The first ring member 4 provides 2 surfaces of sealing 9a, 9c contacting the third ring member 7, and the second ring member 6 provide 2 surfaces of sealing 9b, 9d contacting the third ring member 7.

According to a second aspect, the present invention relates to a roller cone drill bit 100. An example of a perspective three dimensional view of a roller cone drill bit is represented in the FIG. 9. A portion of such a roller cone drill bit 100 is represented on FIGS. 5a and 6a. The roller cone drill bit 100 comprises:
A bit leg 10;
At least one shaft or journal pin 2 extending from a portion of the bit leg 10;
A roller cone 3 rotatably mounted on the shaft 2.
   The roller cone drill bit is characterized in that it comprises a seal assembly 1 as disclosed herein above. The seal assembly 1 comprises at least:
a first ring member 4 fitted to the first member 10, preferably around said shaft 2, and comprising a first concave and deformable surface 34;
a second ring member 6 fitted inside the said roller cone 3 and comprising a second concave and deformable surface 36 adapted to face the first concave surface 34; and
a third ring member 7 more rigid and less deformable than both the said first concave surface 34 and the said second concave surface 36, the third ring member 7 being arranged between the said first concave surface 34 and the said second concave surface 36.

Each of the first concave surface 34 and second concave surface 36 have an orientation.

The seal assembly 1 of the roller cone drill bit 100 may comprises any other features as disclosed in the description of the seal assembly 1 herein above.

The roller cone 3 comprises hard material cutting inserts 3a, preferably made of tungsten carbide. Preferably, the roller cone 3 comprises a base 13 facing a substantially flat surface 12 of the bit leg 10. The base 13 of the roller cone 3 comprises a cavity designed for inserting a shaft or journal pin 2 rising from the substantially flat surface 12 of the bit leg 10 and for the bearing members and cone retention ball bearings 5. Both journal pin 2 and cavity of the roller cone 3 comprises complementary bearing races for cone retention ball bearings 5, radial bearings 22 and thrust bearing 24. The journal pin 2 further comprises a first channel 19 for introducing balls 5. The first channel 19 is closed by a ball retainer 23 fixed, typically by welding, inside the channel once the balls 5 are in place. More preferably, the journal pin 2 further comprises a second channel 20 connected to the first channel 19 and to a reservoir 18 containing a lubricant for lubrication of the bearing system 5, 22 and 24. The channel for the lubricant to enter the bearing is through the ball race. It is from that point that the lubricant is distributed throughout the bearing system. When lubricated, the space between the journal pin 2 and the cavity of the roller cone 3 is completely filled with lubricant. A third channel 21 may be provided in connection with one of the first or second channel and one of the radial bearings 22 or thrust bearings 24 for allowing the circulation of the lubricant.

The seal assembly is arranged in the roller cone drill bit such that said first ring member 4 and said second ring member 6 provide multiple sealing surfaces 9a, 9b, 9c, 9d contacting said third ring member 7 thus allowing the said third ring member 7 to rotate freely between the said first concave surface 34 and the second concave surface 36 and in self-alignment relative to the movement of the rotatable member 3.

Preferably, the journal pin 2 comprises a bottom section adjacent to the bit leg, the bottom section having a bigger diameter for making a press fit between that bottom section and the first ring member 4.

The said cavity of the roller cone comprises a recess or preferably a groove 11 having for example a rectangular cross section machined parallel to the base 13 of the roller cone for inserting said seal assembly.

The method of mounting the roller cone drill bit includes the steps of:
pressing the first ring 4 on the bottom section of the journal 2;
inserting the third ring member 7 into the cavity of the first ring 4;
putting the radial bearings 22 and the thrust bearings 24 onto the races provided on the journal and putting the second ring 6 into the recess or groove 11 of the roller cone 3;
pressing the roller cone onto the loaded journal until the third ring member 7 is in place into the cavity of the second ring member 6;
inserting the balls 5 into the channel 19 provided through the journal 2 for loading the bearing races and maintaining the roller cone 3 on the journal 2;
welding the ball retainer 23 into the said channel 19.

In another embodiment of the invention, as presented on FIGS. 6a and 6b the substantially flat surface 12 of the bit leg 10 facing the base 13 of the roller cone, and the base of the roller cone both comprises a semi-circular cross section groove 14a, 14b aligned with each other, centered on the central axis 15 of the journal pin 2, and in which is disposed a fourth ring member 16. The fourth ring member provides a first barrier preventing the debris of cutting to penetrate between the journal pin and the roller cone. There is a clearance between the fourth ring member 16 and the space formed by the two facing semi-circular grooves 14a, 14b for equilibrating pressures.

Preferably, the fourth ring member 16 comprises a cavity 17 at its periphery. More preferably, the cavity 17 of the fourth ring member 16 extends along the entire perimeter of the said fourth ring member 16. Larger particles of debris are trapped by this cavity and fluid flowing through this cavity tends to remove these particles out of the cavity and out of the space between the base of the roller cone and the flat surface of the body facing the base of the roller cone.

More preferably, fourth ring member 16 is made of a material having a Young's modulus larger than 100 GPa such as the possible materials disclosed hereinabove for the said third ring member.

Preferably, said fourth ring member 16 is coated with an abrasive resistant coating such as Titanium nitride, or aromatic polyamine (Kevlar). Said fourth ring member can also be carburized or boronized.

Preferably, the roller cone bearing surfaces are hardened, and journal surfaces are hardened typically by carburizing or boronizing the steel surfaces.

The seal assembly as disclosed herein above and its use for sealing a space formed by a journal and a cavity of a roller cone provides the advantages of an improved sealing and an increased lifetime of the sealing relative to prior art sealing means, in particular in the field of roller cone drill bits.

While drilling with a roller cone drill bit comprising the seal assembly as disclosed hereinabove, the relative speed of the sealing ring 7 that floats freely in the cavities formed by 34 and 36 will be typically less than the rotational speed of the cone, thus limiting the heat generation of the seal due to frictional forces. This improvement of this seal was not possible with other typical sealing system configurations.

The invention may also be described as follows:
The seal assembly 1 for sealing between a shaft 2 and a rotatable member 3 adapted for rotating around said shaft comprises:
a first ring member 4 adapted for fitting around said shaft 2 and having a first outer′ surface 34 oriented radially outwards;
a second ring member 6 adapted for fitting inside said rotatable member 3 and having an second inner surface 36 oriented radially inwards and facing said first outer surface 34 along an length extending in a direction parallel to said shaft; and
a third ring member 7 between said second inner 36 and said first outer surface 34, the radial distance between said second inner surface 36 and said first outer surface 34 being larger at the middle of said length and becoming smaller towards the extremities thereof.
   Preferably, the third ring member 7 is made of a material having a Young modulus higher than the Young modulus of the material of the first ring member 4 in the vicinity of the first outer surface 34 and/or of the material of the second ring member in the vicinity of the second inner surface 36.
   Preferably, the third ring member 7 is made of a material having a young modulus higher than 100 GPa.

1. A seal assembly (1) for sealing between a fixed member (10) and a rotatable member (3) adapted for rotating around an axis in relation to said fixed member (10), the seal assembly (1) comprising:
a first ring member (4) adapted for being fitted in or on said fixed member (10) circumferentially around said axis and having a first surface (34);
a second ring member (6) adapted for being fitted circumferentially in or on said rotatable member (3) and having a second surface (36) facing said first surface (34) along a length; and
a third ring member (7), made of a material having a Young's modulus greater than about 100 GPa, between said second (36) and said first surface (34),
wherein the distance between said second surface (36) and said first surface (34) is larger at the middle of said length and becomes smaller towards the extremities thereof.

2. The seal assembly (1) of claim 1, wherein said third ring member (7) is made of a material having a Young's modulus higher than the Young's modulus of the material of said first ring member (4) proximate to the first surface (34) or of the material of the second ring member (6) proximate to the second surface (36).

3. (canceled)

4. The seal assembly (1) of claim 1, wherein said first surface (34) and said third ring member (7) have a curvature such that said third ring member (7) is contacting said first surface (34) at two points (9a, 9c).

5. The seal assembly (1) of claim 1, wherein said second surface (36) and said third ring member (7) have a curvature such that said third ring member (7) is contacting said inner surface (36) at two points (9b, 9d).

6. The seal assembly (1) of claim 1, wherein said first outer surface (34) and said third ring member (7) have a curvature such that said third ring member (7) is contacting said first outer surface (34) at one point (9a).

7. The seal assembly (1) of claim 1, wherein said second inner surface (36) and said third ring member (7) have a curvature such that said third ring member (7) is contacting said second inner surface (36) at one point (9b).

8. The seal assembly (1) of claim 1, wherein the material of said first ring member (4) in the vicinity of the first surface (34) and/or the material of the second ring member in the vicinity of the second surface (36) comprises an elastomer.

9. The seal assembly (1) of claim 1, wherein said third ring member (7) is coated with a friction-reducing material.

10. The seal assembly (1) of claim 1, wherein said first ring member (4) is adapted for fitting on or in said fixed member (10) in a non-rotatable way.

11. The seal assembly (1) of claim 1, wherein said second ring member (6) is adapted for fitting on or in said rotatable member (3) in a non-rotatable way.

12. The seal assembly (1) of claim 1, wherein said fixed member comprises a shaft (2) and said rotatable member comprises a cavity (60), said shaft (2) and said cavity (60) being adapted for rotation of said rotatable member (3) around said axis.

13. The seal assembly (1) of claim 12, wherein said first ring member (4) is adapted for being fitted around said shaft (2), said first surface (34) being oriented radially outwards; said second ring member (6) is adapted for being fitted inside said cavity of said rotatable member (3), said second inner surface (36) being oriented radially inwards and facing said first surface (34), said length extending in a direction parallel to said shaft.

14. The seal assembly (1) of claim 12, wherein said first ring member (4) is adapted for being fitted on a surface of fixed member (10) perpendicular to said shaft (2), said first surface (34) being oriented axially in the direction of said shaft (2); said second ring member (6) is adapted for being fitted on said rotatable member (3), said second surface (36) being oriented axially in the direction of said shaft (2) and facing said first surface (34) said length extending in a direction radial to said shaft (2).

15. The seal assembly (1) of claim 12, wherein said first ring member (4) is adapted for being fitted on a surface of said fixed member (10) oriented in a direction intermediate between a radially outwards direction and an axial direction in the direction of said shaft; said second ring member (6) is adapted for being fitted inside said rotatable member (3) said second inner surface (36) being oriented in a direction facing said first outer surface (34), said length extending in a direction perpendicular to said intermediate direction.

16. The seal assembly (1) of claim 1, wherein said fixed member comprises a cavity (60), and said rotatable member comprises a shaft (2) said shaft (2) and said cavity (60) being adapted for rotation of said rotatable member (3) around said axis.

17. The seal assembly (1) of claim 16, wherein said first ring member (4) is adapted for being fitted inside said cavity of said fixed member, said first surface (34) being oriented radially inwards; said second ring member (6) is adapted for being fitted around said shaft of said rotatable member (3), said second surface (36) being oriented radially outwards and facing said first surface (34), said length extending in a direction parallel to said shaft.

18. The seal assembly (1) of claim 16, wherein said first ring member (4) is adapted for being fitted on a surface of fixed member (10) perpendicular to said cavity (n°), said first surface (34) being oriented axially in the direction of said shaft (2); said second ring member (6) is adapted for being fitted on said rotatable member (3), said second surface (36) being oriented axially in the direction of said shaft (2) and facing said first surface (34) said length extending in a direction radial to said shaft (2).

19. The seal assembly (1) of claim 16, wherein said first ring member (4) is adapted for being fitted on a surface of said fixed member (10) oriented in a direction intermediate between a radially inwards direction and an axial direction in the direction of said shaft; said second ring member (6) is adapted for being fitted around said rotatable member (3) said second inner surface (36) being oriented in a direction facing said first outer surface (34), said length extending in a direction perpendicular to said intermediate direction.

20. A roller cone drill bit (100) comprising
a bit leg (10);
at least one shaft (2) extending from a portion of said bit leg (10); and
a roller cone (3) rotatably mounted on said shaft (2),
wherein the roller cone drill bit comprises a seal assembly (1) having a first ring member (4) fixed to a shaft (2) and a second ring member (6) fixed to said roller cone (3).

21. The roller cone drill bit (100) of claim 20, wherein the roller cone (3) comprises a groove (11) for insertion of said second ring member (6).

22. The roller cone drill bit (100) of claim 21, wherein the bit leg (10) comprises a first substantially flat surface (12), said roller cone (3) comprises a second substantially flat surface (13) facing said first substantially flat surface (12), both surfaces (12, 13) having a circular groove (14, 14′) aligned with each other, centered on the central axis (15) of the shaft (2), and in which is disposed a fourth ring member (16).

23. The roller cone drill bit (100) of claim 22, wherein said fourth ring member (16) comprises a cavity (17) at a periphery of the cavity.

24. The roller cone drill bit (100) of claim 23, wherein said cavity (17) of said fourth ring member (16) extends along the entire perimeter of the said fourth ring member (16).

25. The roller cone drill bit (10) of claim 24, wherein said fourth ring member (16) is made of a material having a Young's modulus greater than about 100 GPa.

26. The roller cone drill bit (10) of claim 25, wherein said fourth ring member (16) is coated with a friction-reducing material.
